(19) United States
(12) Patent Application Publication
(10) Pub. No.: US 2007/0022000 A1
(43) Pub. Date: Jan. 25, 2007

(54) Data analysis using graphical visualization

(75) Inventors: Andrew J. Bodart, New York, NY (US); William E. Vallier, Bound Brook, NJ (US)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: Accenture LLP, Palo Alto, CA (US)

(21) Appl. No.: 11/186,819

(22) Filed: Jul. 22, 2005

(51) Int. Cl. G07G 1/00

(52) U.S. Cl. 705/10

(57) ABSTRACT

Methods and systems are provided for creating interactive graphical representations (e.g., interactive radial graphs) of operational data in order to enhance root cause analysis and other forms of operational analysis. Graphical nodes represent potential sources of operational variations. Graphical edges linking nodes represent relationships among the potential sources. Graphs may be useful in assessing inefficiencies in call center operations, manufacturing processes, and other processes.

### FIELD OF THE INVENTION

The invention relates generally to electronic data visualization. More particularly, the invention provides for using electronic data visualization to analyze business intelligence data.

### BACKGROUND

Industrial and commercial processes lend themselves to business intelligence analysis. Such analysis can be used to streamline different workplace processes, whether in a call center, a manufacturing assembly line, or any other process. By analyzing the measured data and discovering the sources of a particular inefficiency or a particular success, managers can revise procedures, upgrade equipment, provide worker training, or take whatever steps may be necessary to improve the process.

Root cause analysis is one form of business intelligence analysis which seeks to determine the how, what, and why of a particular event. Root cause analysis involves the measurement of data about a process so that causes of particular events can be gleaned therefrom. In the case of a call center, this may include measuring call length, repeat callers, caller satisfaction, successful sales, worker months of experience (attrition), and so forth. In the case of an assembly line, this may include measuring product throughput at various assembly stages, employee morale, number of defective parts, etcetera. The possibilities for data measurement are numerous and may vary by the type of process under examination.

Conventionally, the data measured is analyzed to determine where process efficiencies can be improved. If, for example, a particular call center is getting a higher number of repeat callers than others, data analysis may correlate the increased incidence of repeat calls to other factors, such as lower employee morale over time or a lack of a particular type of training. This analysis may be performed using software packages specialized for this purpose (e.g., Enkata Enterprise Insight Suite™ by Enkata Technologies, Inc.). Such packages may produce textual analysis information, such as is provided in FIGS. 1 and 2.

FIGS. 1 and 2 provide illustrative examples of call center process data analysis results 101, 201 showing the somewhat cumbersome nature of the results. These results, read properly by an experienced analyst, provide insight into the root causes of particular aberrations in the underlying data. By “drilling” through results of interest, an analyst may eventually be able to discover the source of a problem. In FIG. 1, an analyst is able to see the call center products and plans for which the percentage deviation 102 is outside a certain threshold based on the number of repeat phone calls. The analysis engine (e.g., Enkata) which generates these results also provides a relevance score 103, which may indicate the relevance of the deviation to a particular event or anomaly of interest.

Looking at the data from a different perspective, FIG. 2 shows deviation 102 and relevance score 103 by call center location and tenure of the agents involved. Scrolling up and down, and putting all the information from both figures together, an analyst viewing the textual information may eventually determine that agents with 0-3 and 4-6 months of tenure 205 in Atlanta and Spokane 204 may not be properly handling calls regarding various telecommunications products 104, 105, leading to increased repeat calls. This information, however, is apparently not intuitive. An analyst may require a great deal of time and experience in order to make a final conclusion. Moreover, sharing the data with non-experts and company management may be more difficult in a less-intuitive textual format.

Systems and methods are needed for intuitively presenting analyzed process data to enable faster conclusions and to broaden the audience for the information.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

A first embodiment comprises methods for receiving operational data including already-analyzed values indicating variations of interest in the data, transforming the operational data in order to produce a graphical representation, and enabling interactive adjustment of the graphical representation.

A second embodiment includes a system for creating an interactive visual representation comprising a display, input device, memory, and processor configured to retrieve analyzed data, convert potential sources of data variation into graphical nodes, convert relationships among the sources into graphical edges between the nodes, receive a selection of a node, and adjust the layout of the interactive visual representation based on the node selection.

### OVERVIEW OF THE FIGURES

A more complete understanding of the present invention and the advantages thereof may be acquired by referring to the following description in consideration of the accompanying drawings, in which like reference numbers indicate like features, and wherein:

FIGS. 1 and 2 provide illustrative prior art examples of call center process data analysis results;

FIG. 3 is a flow chart illustrating a method for analyzing process data according to one or more aspects of the invention;

FIG. 4 is a flow chart illustrating a method for visualizing analyzed process data according to one or more aspects of the invention;

FIGS. 5, 6, and 7 are illustrative radial graphs for visualizing analyzed process data according to one or more aspects of the invention;

FIG. 8 is an illustrative tree graph for visualizing analyzed process data according to one or more aspects of the invention;

FIG. 9 is an illustrative radial graph including additional visualization options according to one or more aspects of the invention; and

FIG. 10 is an illustrative operating environment in which one or more embodiments of the invention may be implemented.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

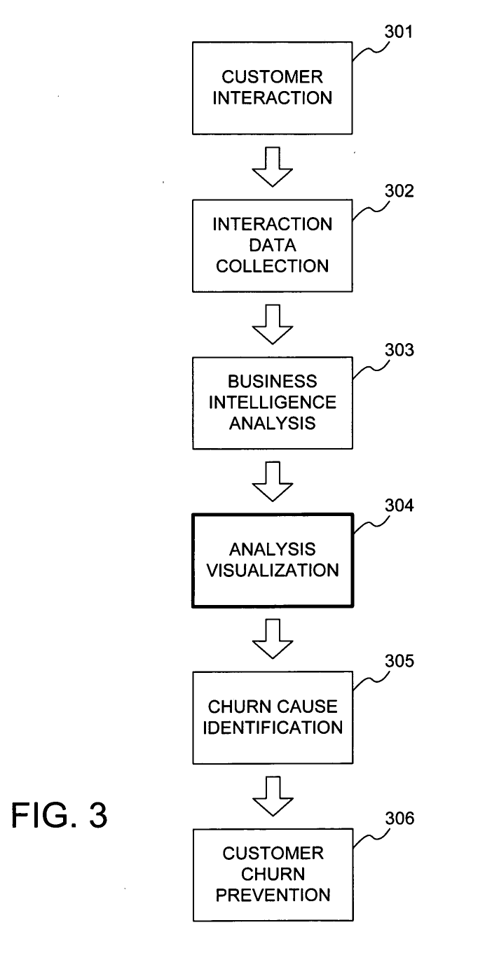

FIG. 3 is a flow chart illustrating a method for analyzing process data. The method shown and described is one of many which may utilize data visualization techniques to assist in the analysis of process data. The method here may be instituted in order to determine the cause(s) of customer chum, which means the loss of customers to competitors. The first step 301 in this method is to determine what part or parts of a process are going to be examined. Here, customer interactions are going to be studied. This may include calls into a call center. Alternatively, in the case of a manufacturing line, the productivity of a manufacturing process may be studied.

At step 302, data about the customer interaction is collected. This may mean collecting more than just data about specific customer interactions (e.g., call length, repeat calls, reason for call, customer satisfaction, etc.), but also about potential causes for problems or successes. In the case of a call center, this may include collecting data about worker tenure, worker training, manager training, equipment failures, worker morale, and so forth. All of this operational data may be stored in one or more databases for eventual analysis.

At step 303, data from one or more sources may be combined and analyzed. Trends may be tracked, and anomalies may be correlated. Analysis may involve performing calculations on huge quantities of interaction data (e.g., millions of calls into a call center) in order to glean additional information, such as number of repeat callers who subsequently left for a competitor. Again, this data can be correlated by geography or over time to aid in the eventual discovery of trends and relationships.

Conventionally, a business analyst would be provided the textual results of data analysis in the form of, for example, a textual web page or spreadsheet. An experienced user may then be able to spot trends and relationships, although navigating reams of analysis results may take a significant amount of time, especially if the business analyst isn't certain where to spot the root cause or causes of data variation. Here, at step 304, a business analyst may utilize one or more interactive visual representations of the data in order to quickly and intuitively find anomalies and determine relationships among the potential sources of variation. Radial graphs or tree graphs are just a few of the possible interactive visual representations which may aid an analyst at this step.

Using an interactive visual representation of the data, an analyst may determine the root cause or causes of higher customer chum among repeat callers at step 305. For example, certain training may be lacking among workers at a particular call center or frequent equipment malfunctions at a call center may result in frustrated callers. At step 306, this information can be used by managers to alleviate the problems and prevent further customer chum. For example, managers may be able to institute new training for their employees, or they may be able to replace malfunctioning equipment.

Once again, the method outlined in FIG. 3 is merely illustrative. Other industries or activities may use interactive visual representations of process data to further understand the sources of successes or failures within the process.

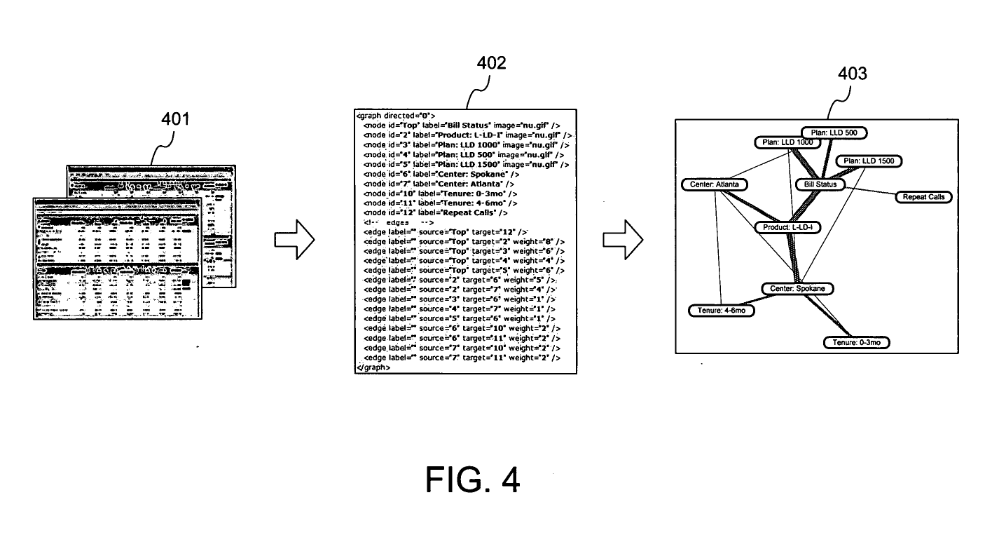

FIG. 4 illustrates a method for producing an interactive visual representation 403 of process data according to one or more aspects of the invention. Here, data 401 produced by an analysis software package is transformed into a graph description format for eventual rendering as interactive visual representation 403.

Using one of many methods, data 401 is transformed into format 402. One method may involve exporting data 401 in a standardized format (e.g., comma separated values (CSV)). Alternatively, a web page or pages (such as those generated by Enkata) may be read and the data “scraped” from the page. Based on the values received, a file 402 is assembled using a graph description format. File 402 here is an extensible mark-up language (XML) file, but other formats may be used. File 402 contains information for creating nodes and relationships (edges) using data 401 mapped into graphical components. Interactive visual representation 403, here a radial graph, is then generated using file 402 as instructions for creating the visual representation. Such a graph may be generated using a third-party graph generating tool, such as the open-source interactive information visualization project, “prefuse.”

Alternative methods for transforming analyzed process data into an interactive visual representation are possible. For example, data need not be transformed into the intermediary step of the graph description format. If programmatic access to the data is available within an analysis software package (e.g., through an application programming interface or API), then an interactive visual representation can be created directly without intermediate formats. Furthermore, this functionality may be included within an analysis software package itself.

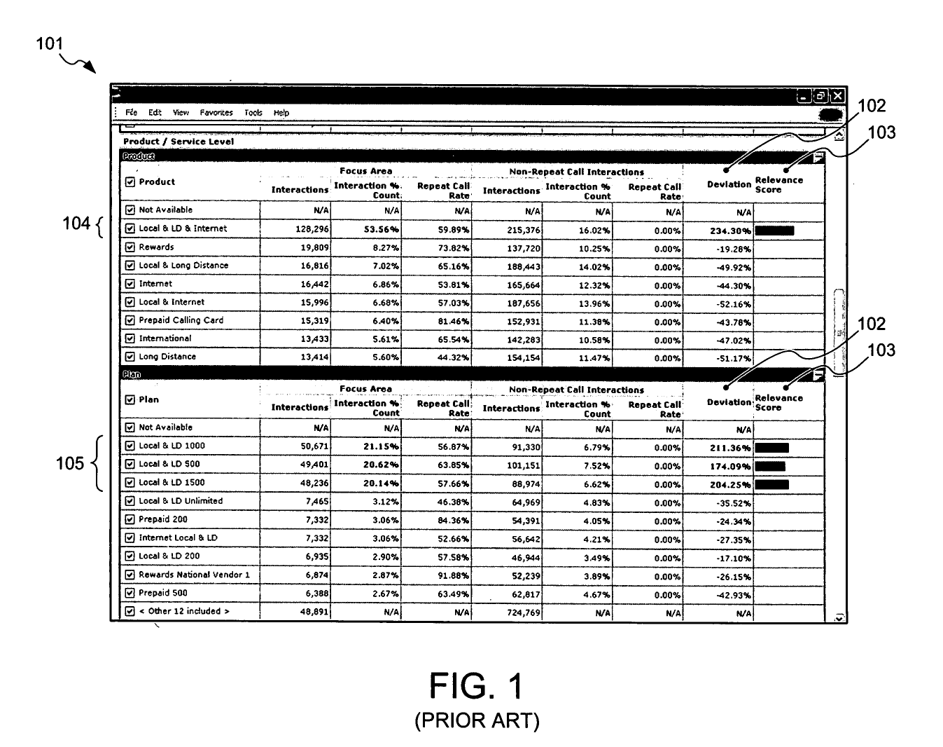

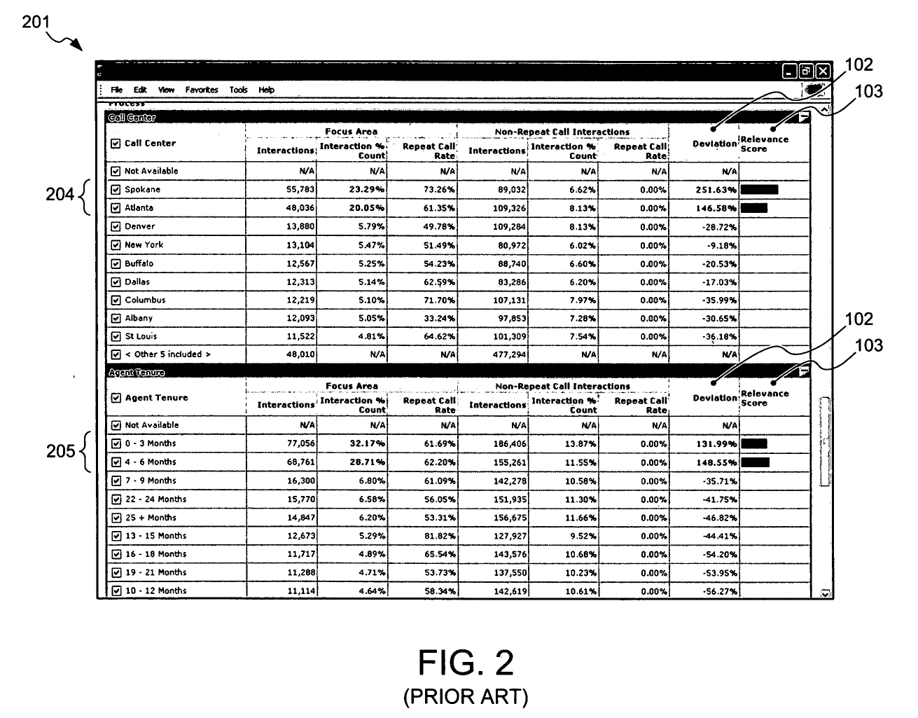

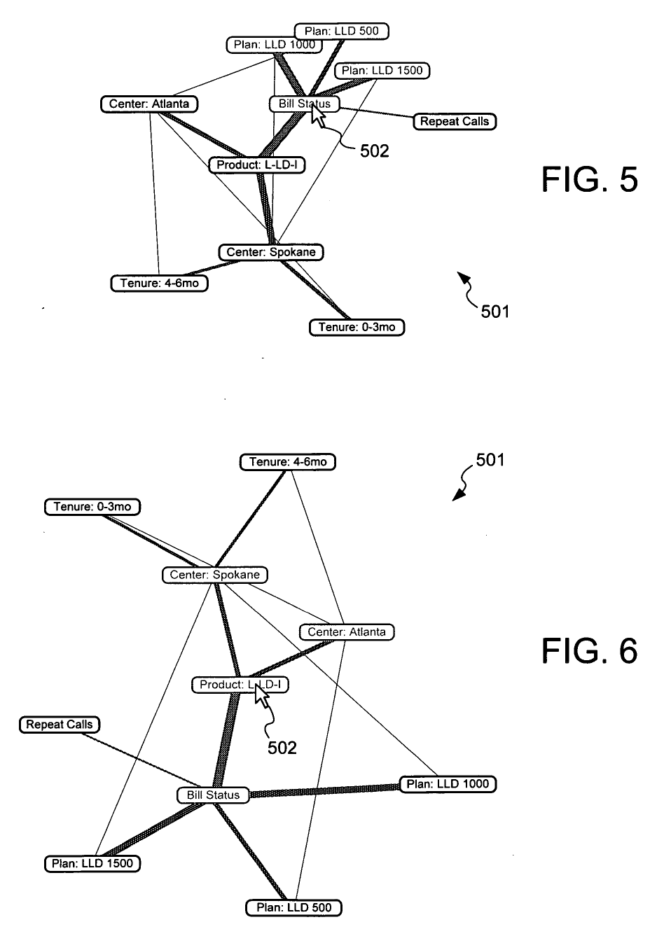

FIGS. 5, 6, and 7 depict separate views of an illustrative radial graph for visualizing analyzed process data according to one or more aspects of the invention. Such an interactive graph may be utilized by an analyst to visualize the interactions of potential root causes of data variation in a process. FIG. 5 depicts a first view of an interactive radial graph created using data from the analyses of FIGS. 1 and 2. Here, variations in “Bill Status” inquiry data are being probed, as indicated by the location of selection point 502. The radial graph centers on the selected node. The nodes here represent potential sources of process data variation, indicating possible inefficiencies (or successes) in the process. The links (edges) between nodes represent the relevance of sources to each other. The wider the edge, the higher the relevance factor. This may indicate a high correlation between factors, and therefore indicate component causes of data variation.

By navigating through the graph with selection point 502, an analyst may be able to reorient the nodes and edges to re-center on selected nodes. Node selection may be accomplished by moving and clicking an attached mouse which controls the selection point 502, or by entering keyboard commands on an attached keyboard. In FIG. 6, selection point 502 has moved to “Product: L-LD-IZ” (Product: Local & Long Distance & Internet) and the graph has reoriented around the newly selected node. In going from the view in FIG. 5 to the view in FIG. 6, the radial graph is animated so that an analyst can easily understand how the nodes have moved. Here, the relationships and nodes are retained in the graph, but are merely moved around to help the viewer understand the relationships by traversing down the causal tree.

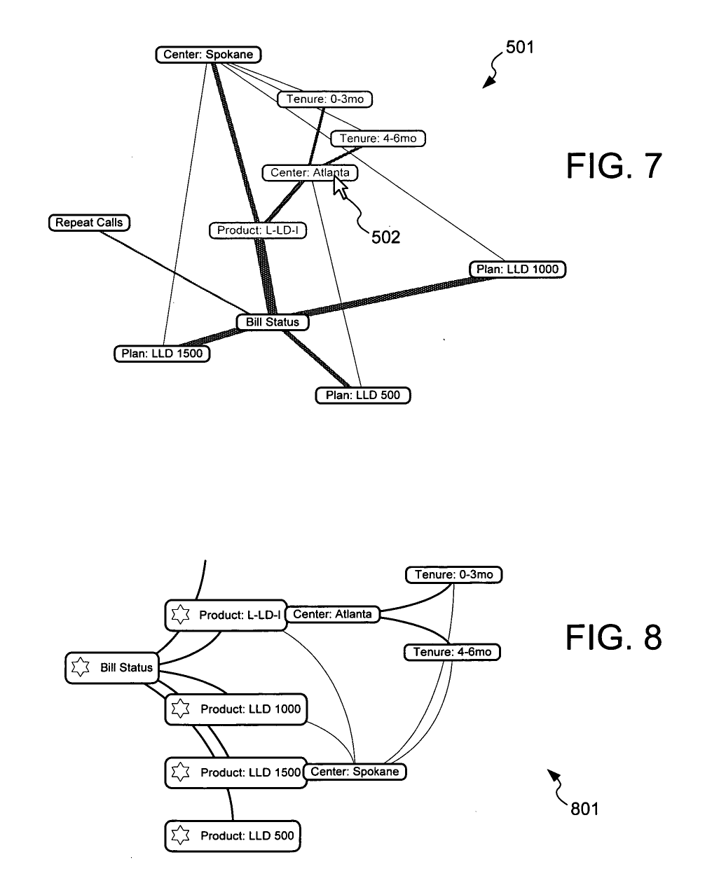

FIG. 7 presents a third view of the same interactive radial graph. Once again, an analyst has moved selection point 502 to re-center the graph on a new node, “Center: Atlanta.” Each re-centering has caused the nodes to move and the colors of the nodes to change. These color changes may cause the currently selected node (and its closest neighbors) to be highlighted, making it easier for an analyst to see nodes of interest. Color changes, font styles, icons, and line thickness among the nodes may all be used to represent other values as well. Node color, for example, may be used as a breadcrumb trail, showing the most recently selected nodes. Font style, as another example, may also be used to represent the magnitude of the “relevance” value. Likewise, edge thickness and color may be used to represent relevance, percent deviation from a norm, or other factors of interest to an analyst.

Additional animations or graph changes may occur when selecting nodes and edges in a graph. For example, selecting a node may “drill down” into components which make up the particular node, revealing previously unseen nodes. In addition, nodes and edges may disappear either off the edge of a graph or fade into the background depending on their immediate relevance to the analyst. Likewise, nodes and edges may reappear in similar fashion.

As an analyst selects various nodes representing analyzed process data, the analyst may quickly develop insights about data variations. For example, by navigating through the respective nodes, an analyst viewing graph 501 may quickly realize that Bill Status inquiry issues are related to a particular set of products among a particular subset of call center workers in certain cities.

FIG. 8 is an illustrative tree graph 801 for visualizing analyzed process data according to one or more aspects of the invention. Tree graph 801 may present the same information presented in radial graph 501, but in a more hierarchical fashion. This may be useful when relationships between nodes are generally of the parent-child variety, or where the relationships tend to be one-to-many, as opposed to many-to-many. Interactivity in tree graph 801 may re-center around selected nodes, as with the radial graphs, but also may involve alternative animations to enhance the work of analysts. Other types of interactive visual representations are certainly available, including distortion graphs, force-directed radial graphs, and so forth. Any interactive graphical representation of data may suit for particular types of process analysis.

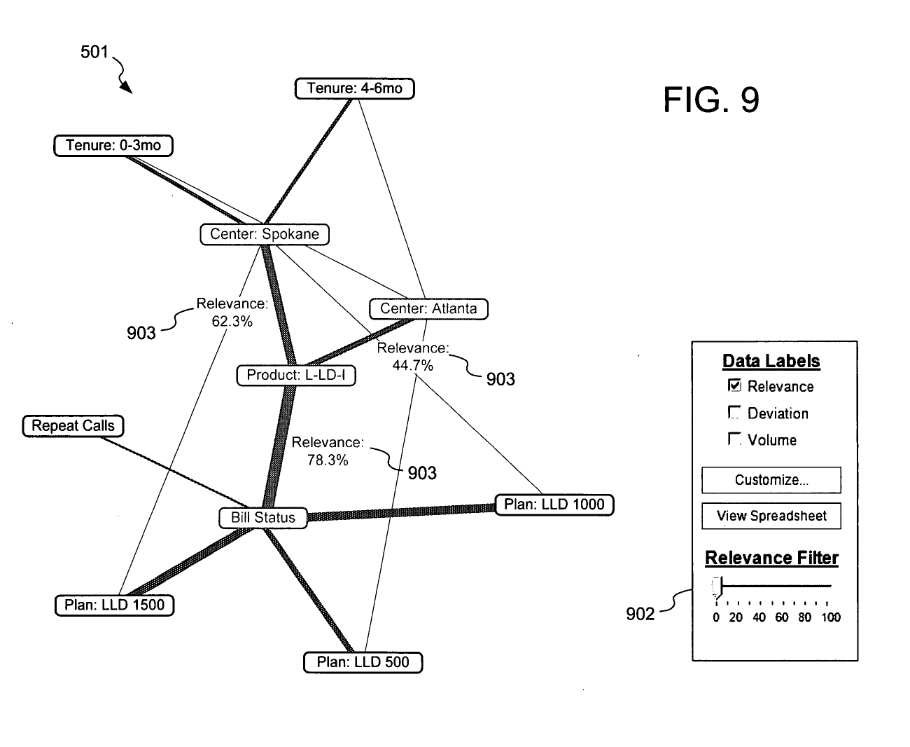

FIG. 9 is an illustrative radial graph 501 presenting additional visual options which may be associated with interactive visualizations. Here, visualization control panel 902 is included to show how a radial graph (or any other type of graph) can be further customized to aid the understanding of viewers. Data labels 903 can be added to edges or other parts of the graph in order to provide more detail about the underlying data or to provide other information relevant for understanding. Here, the relevance values are displayed as labels accompanying the links between nodes. Other values may include deviation or volume, and so forth. Furthermore, a data filter (e.g., a relevance filter) may be included so as to display or hide nodes and/or links which satisfy a particular threshold value. Here, an analyst may slide the slider to only show (or hide) edges which meet or exceed a given relevance value. Users may further customize the graph, including changing colors, thicknesses, or even the underlying data. Moreover, a control panel 902 such as the one shown here may allow direct access to the underlying spreadsheets or data.

In order to further facilitate the activities of an analyst attempting to discern a root cause or other item of interest, the initial radial graph displayed may include only those nodes in the “best path” or most relevant to the root cause analysis. By deleting extraneous nodes, an analyst may even more quickly determine a root cause. Other values of interest, including percent deviation, may also be utilized in this fashion, again showing an analyst the “best path” to the highest deviation percentage involved. Such a graph may only show a single line of connected nodes, leading from the highest level node of interest to the most relevant “root source” node.

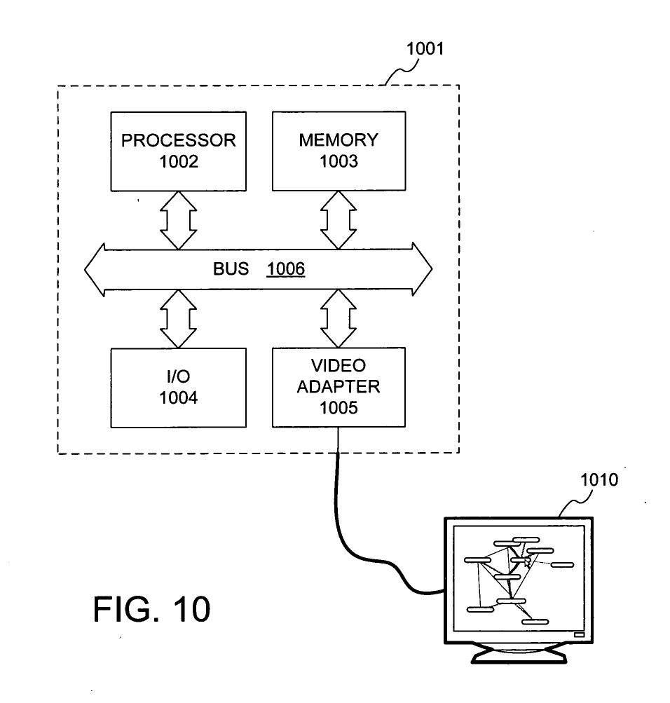

FIG. 10 is an illustrative operating environment in which one or more embodiments of the invention may be implemented. Computer 1001 may be any sort of hardware minimally containing the components shown here, including at least one processor 1002, memory 1003, input/output 1004, video adapter 1005, and bus 1006 to link the components. This includes desktop computers, laptop computers, servers, cell phones, personal digital assistants (PDAs), and so forth. Optionally, display 1010 is attached to computer 1001, although a display may be connected indirectly (e.g., via a network connection), or integrated into the computer. Memory 1003 may include non-volatile memory such as a hard drive or flash memory, as well as volatile memory devices such as cache or various forms of dynamic random access memory (DRAM). Memory 1003 may store executable instructions which, when sent to processor 1002, causes computer 1001 to perform the steps required. Input/output 1004 may include interfaces for keyboard or mouse entry, or for other peripheral devices such as a scanner, a printer, a network connection, and so forth. Optionally, functional components displayed within computer 1001 may be combined or separated into a single or multiple functional blocks. Bus 1006 may include more than one bus, linking different functional components through different communication paths.

Other industries and processes having larger volumes of data to track and/or correlate may similarly be aided by the interactive visualization techniques described here. These may include pharmaceuticals (e.g., clinical trials), insurance (e.g., claims and adjustments), healthcare (e.g., claims processing), retail (e.g., customer loyalty programs), finance & banking (e.g., lending decision support), manufacturing, (e.g., supply chain analysis) and so forth.

The present subject matter has been described in terms of preferred and exemplary embodiments thereof. It is to be understood that the subject matter defined in the appended claims is not necessarily limited to the specific features or acts described above. Rather, the specific features and acts described above are disclosed as example forms of implementing the claims.

We claim:

1. A computer-implemented method for visualizing call center operational data, the method comprising:
receiving analyzed process data, wherein the analyzed process data comprises operational measurements pertaining to one or more call centers, and wherein the measurements have been analyzed to determine variation from a standard;
transforming the analyzed process data to produce a radial graph, wherein the radial graph comprises nodes representing potential sources of variation and the radial graph also comprises one or more edges representing relationships among the potential sources of variation; and
enabling interactive adjustment of the radial graph.

2. A computer-implemented method for visualizing process variation, the method comprising:
receiving analyzed process data, wherein the analyzed process data comprises data measurements pertaining to a process, and wherein the measurements have been analyzed to determine process variation;
transforming the analyzed process data to produce a graphical representation, wherein the graphical representation comprises visual cues representing potential sources of process variation and one or more relationships among the potential sources of process variation; and
enabling interactive adjustment of the graphical representation.

3. The computer-implemented method of claim 2, wherein the analyzed process data further comprises a percentage deviation value.

4. The computer-implemented method of claim 3, wherein the analyzed process data further comprises a relevance score.

5. The computer-implemented method of claim 4, wherein the analyzed process data comprises call center operational measurements.

6. The computer-implemented method of claim 4, wherein the analyzed process data comprises pharmaceutical clinical trial measurements.

7. The computer-implemented method of claim 4, wherein the analyzed process data comprises healthcare claims processing measurements.

8. The computer-implemented method of claim 4, wherein the analyzed process data comprises insurance claims and adjustments measurements.

9. The computer-implemented method of claim 4, wherein the analyzed process data comprises retail operational measurements.

10. The computer-implemented method of claim 4, wherein the analyzed process data comprises financial institution lending decision support measurements.

11. The computer-implemented method of claim 4, wherein the analyzed process data comprises supply chain operational measurements.

12. The computer-implemented method of claim 2, wherein the graphical representation comprises a radial graph.

13. The computer-implemented method of claim 12, wherein a first node in the radial graph represents a first potential source of process variation.

14. The computer-implemented method of claim 13, wherein a second node in the radial graph represents a second potential source of process variation, and an edge in the radial graph linking the first node and the second node represents a relevance between the first and the second potential sources of process variation.

15. The computer-implemented method of claim 2, wherein the graphical representation comprises a tree graph.

16. The computer-implemented method of claim 2, wherein transforming the analyzed process data comprises generating extensible mark-up language (XML).

17. The computer-implemented method of claim 1, wherein the analyzed process data further comprises a percentage interaction volume.

18. A system for creating an interactive visual representation of analyzed process data, the system comprising:
a display, for displaying the interactive visual representation;
an input device;
a memory, for storing analyzed process data, wherein the analyzed process data comprises data measurements pertaining to a process, and wherein the measurements have been analyzed to determine process variation; and
a processor, configured to perform steps of:
retrieving the analyzed process data from the memory;
converting a first set of values from the analyzed process data into graphical nodes for display in the interactive visual representation;
converting a second set of values from the analyzed process data into graphical edge for display in the interactive visual representation, wherein each graphical edge is associated with at least one node;
receiving a selection of a node from the input device; and
modifying the layout of the interactive visual representation based on the selection of the node.

19. The system of claim 18, wherein the interactive visual representation comprises a radial graph.

20. The system of claim 19, wherein a first node in the radial graph represents a first potential source of process variation.

21. The system of claim 20, wherein a second node in the radial graph represents a second potential source of process variation, and an edge in the radial graph linking the first node and the second node represents a relevance between the first and the second potential sources of process variation.

22. The system of claim 21, wherein modifying the layout of the interactive visual representation based on the selection of the node comprises re-centering the layout around a selected node.

23. The system of claim 18, wherein the interactive visual representation comprises a tree graph.

24. The system of claim 18, wherein the analyzed process data comprises call center operational data.

25. The system of claim 18, wherein the analyzed process data comprises pharmaceutical clinical trial measurements.

26. The system of claim 18, wherein the analyzed process data comprises healthcare claims processing measurements.

27. The system of claim 18, wherein the analyzed process data comprises insurance claims and adjustments measurements.

28. The system of claim 18, wherein the analyzed process data comprises retail operational measurements.

29. The system of claim 18, wherein the analyzed process data comprises financial institution lending decision support measurements.

30. The system of claim 18, wherein the analyzed process data comprises supply chain operational measurements.

31. A computer-implemented method for analyzing operational data, the method comprising:
receiving operational data;
determining operational variations based on the operational data;
rendering a graphical representation to display potential sources of the operational variations as nodes;
rendering the graphical representation to display relationships between the potential sources of operation variations as edges between the nodes; and
enabling interactive manipulation of the graphical representation.

32. The computer-implemented method of claim 31, wherein the interactive visual representation comprises a radial graph.

33. The computer-implemented method of claim 32 further comprising rendering the thickness of the edges between the nodes based on a determined relevance value.

34. The computer-implemented method of claim 33, wherein only those potential sources of operational variation that are directly relevant to an analysis are displayed on the radial graph.

35. The computer-implemented method of claim 31, wherein the interactive visual representation comprises a tree graph.
